(19) United States
(12) Patent Application Publication
(10) Pub. No.: US 2026/0338529 A1
(43) Pub. Date: Oct. 29, 2026

(54) KIT AND METHOD FOR FORMING A SUBSTRATE BENEATH A MITERED COUNTERTOP OVERHANG

(71) Applicant: STONE SUBSTRATE SOLUTIONS, LLC, NAPLES, FL (US)

(72) Inventor: MARC BEAUDET, NAPLES, FL (US)

(21) Appl. No.: 19/660,731

(22) Filed: Apr. 28, 2026

Related U.S. Application Data
(60) Provisional application No. 63/795,841, filed on Apr. 28, 2025.

(51) Int. Cl. G01B 5/14

(52) U.S. Cl. CPC G01B 5/14

(57) ABSTRACT

A kit for providing a substrate beneath an overhang region of a mitered countertop is disclosed. The kit includes a plurality of shims having predetermined discrete thicknesses, a substrate board, and a dimensioning guide configured to correlate countertop thickness and mitered edge height to a selected combination of the shims. The shims are arrangeable to define a spacer height that aligns the substrate board with a lower edge of the mitered countertop. In some embodiments, the substrate board comprises a lightweight, water-resistant polymer foam material. The dimensioning guide may be provided as a printed chart or digital interface.

### REFERENCE TO RELATED APPLICATIONS

This application is a non-provisional which claims the benefit of the filing date of U.S. Provisional Application Serial No. 63/795,841 filed Apr. 28, 2025, the subject matter of which is incorporated herein by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of countertop installation systems, and more specifically to the field of installation kits for mitered countertop overhangs.

### BACKGROUND OF THE INVENTION

In the installation of mitered-edge countertops, particularly those featuring overhangs, it is commonly necessary to construct a substrate beneath the overhang to support the extended surface. Traditional methods for fabricating such substrates typically involve the use of plywood, stone shims, adhesives, and labor-intensive cutting and assembly processes. These approaches are associated with numerous drawbacks that impact both installation efficiency and final build quality.

One significant issue with existing substrate installation practices is the time required for sourcing, transporting, and preparing materials. Plywood must often be purchased in full-size sheets from off-site vendors, requiring substantial time commitments for travel and procurement. Once acquired, plywood must be precisely cut to size, often using power tools or specialty blades, such as diamond-tipped saws, which add to material wear and overall tool costs.

Another problem lies in the adjustment and alignment of the substrate with the mitered edge of the countertop. Installers frequently resort to stacking stone or other rigid shims of various thicknesses to achieve the correct height, a process that is imprecise and inconsistent. The variability in shim material and size can lead to misalignment, adversely affecting the aesthetic appearance of the countertop.

Additionally, the conventional use of adhesives, caulks, and paints to bond and finish the substrate involves multiple steps, including glue application, drying time, sanding, and sealing. These steps not only introduce potential failure points due to adhesive fatigue or moisture penetration, but also extend the installation timeline considerably. In some cases, installers must rely on on-site modifications and improvisation, increasing labor costs and the likelihood of installation errors.

Lastly, the necessity of using specialized cutting tools, such as diamond blades for hard materials, imposes an added expense and requires skilled labor to ensure safety and accuracy. This contributes to an elevated barrier to entry for less experienced installers and complicates jobsite logistics.

As a result, there exists a need for improvements over the prior art and more particularly for a streamlined, cost-effective, and reliable system for forming a substrate beneath a mitered countertop overhang that reduces installation time, eliminates material inconsistencies, and minimizes the need for specialized tools or labor.

### BRIEF SUMMARY OF THE INVENTION

A system and method for providing a substrate beneath an overhang region of a mitered countertop is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter’s scope.

In one embodiment, a kit for providing a substrate beneath an overhang region of a mitered countertop is disclosed. Each shim has a predetermined thickness selected from the group consisting of about 1/4 inch, 1/2 inch, 3/4 inch, and 1 inch. The kit comprises a substrate board having a thickness of about 1/2 inch. The kit comprises a dimensioning guide including indicia that correlate a countertop thickness and a mitered edge height with a selected combination of the predetermined shim thicknesses. The plurality of shims are arrangeable to collectively define a spacer height corresponding to the selected combination of shim thicknesses. The substrate board comprises a polymer foam board having a density less than about one pound per square foot. The dimensioning guide comprises a printed chart including a lookup table relating the countertop thickness and the mitered edge height to the selected combination of shim thicknesses. The dimensioning guide comprises a digital interface configured to output the selected combination of shim thicknesses in response to inputs of the countertop thickness and the mitered edge height. Each shim is pre-cut to a standardized planform dimension corresponding to a peripheral dimension of the substrate board. The substrate board comprises a water-resistant material.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a perspective view of a mitered countertop assembly including a substrate board and a plurality of stacked shims, according to an example embodiment.

FIG. 2 is a side view of the countertop, substrate, and shims, showing relative dimensions and positions of the elements, according to an example embodiment.

FIG. 3 is a rear sectional view of the assembly depicting varying shim thicknesses and their alignment with the substrate and mitered edge, according to an example embodiment.

FIG. 4 is an underside exploded perspective view illustrating the individual components of the system, including the substrate board and various shims, according to an example embodiment.

FIG. 5 is a diagram of a dimensioning guide illustrating a shim selection chart based on countertop thickness and miter edge height, according to an example embodiment.

FIG. 6 is a process flow diagram illustrating a method for forming a substrate beneath a countertop overhang using the disclosed kit, according to an example embodiment.

FIG. 7 is a kit for providing a substrate beneath an overhang region of a mitered countertop, according to an example embodiment.

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system and kit that streamlines the process of forming a substrate beneath a mitered countertop overhang. The system includes a coordinated set of components that work together to eliminate the complexity, labor-intensity, and material inconsistencies found in traditional installation methods. Specifically, the kit comprises: (i) a plurality of foam board shims, each of a defined and selectable thickness; (ii) a substrate board fabricated from the same lightweight foam board material; and (iii) a dimensioning guide configured to determine the appropriate combination of shim thicknesses needed to achieve a flush installation relative to the mitered edge of the countertop.

One of the primary improvements of the disclosed kit is the use of foam board material for both the shims and the substrate board. Unlike conventional plywood or rigid stone components, the foam board is lightweight, easy to cut using standard hand tools, and eliminates the need for diamond blades or heavy-duty saws. This material selection significantly reduces tool requirements and installation hazards, enabling a broader range of users to complete installations on-site with minimal effort and no specialized equipment.

Additionally, the shims included in the kit are pre-manufactured in standardized thicknesses, such as 1/4 inch, 1/2 inch, 3/4 inch, and 1 inch, and are designed to stack uniformly and predictably. This removes the guesswork and variability associated with sourcing and manually cutting stone or wood shims. The foam board shims can be stacked in various combinations to closely match the vertical offset needed to align the substrate board to the mitered edge of the countertop.

The dimensioning guide, such as a printed chart, digital interface, or software application, provides an additional layer of efficiency and standardization. The guide enables an installer to input or reference the countertop thickness and mitered edge height, and quickly determine the precise combination of shim thicknesses needed. This prevents trial-and-error approaches on-site, minimizing material waste and improving installation speed and accuracy, where a matrix of miter thicknesses and countertop types yields a suggested shim configuration and board thickness for a flush finish.

In some embodiments, the dimensioning guide includes a digital interface configured to output the selected combination of shim thicknesses in response to inputs of the countertop thickness and the mitered edge height. The digital interface is configured to receive user inputs corresponding to the countertop thickness and the mitered edge height through an input mechanism such as a touchscreen, keypad, or graphical user interface. The digital interface processes the inputs using a predefined correlation or algorithm and generates an output identifying the selected combination of shim thicknesses. The output may be presented as numerical values, visual indicators, or step-by-step guidance, thereby enabling an installer to quickly determine and implement an appropriate shim configuration for the installation condition.

Importantly, all components in the kit are dimensionally compatible. The shims are pre-cut to match the width and depth of the substrate board, reducing the need for on-site trimming or shaping. The substrate board itself is dimensioned to span a substantial portion of the underside of the overhang, remaining concealed from view. With a thickness of approximately 1/2 inch, the board integrates smoothly into common countertop designs without requiring adjustments to the visible portions of the installation.

The disclosed kit addresses numerous inefficiencies in the prior art by offering a pre-configured, modular system that is lightweight, tool-friendly, and dimensionally precise. The design reduces labor costs, material waste, and risk of error while enabling even non-specialist installers to complete the underlayment beneath mitered countertop overhangs with professional-grade precision and efficiency.

Traditional methods for building substrate under a mitered countertop overhang typically involve multiple steps with high material and labor burdens. Installers must source plywood sheets, transport them from vendors, manually cut them to fit using power tools or diamond blades, and gather or custom-cut rigid stone shims to fill gaps between the mounting surface and the substrate. In addition to adhesive bonding, the process may also include caulking, painting, sanding, and sealing. In a representative example, these steps may cumulatively demand approximately two hours and fifteen minutes of time and generate an average cost of over $110 per installation, including labor.

In contrast, the disclosed kit enables a streamlined installation that takes approximately fifteen minutes, at a significantly reduced total cost of approximately $62. As a representative example, rather than sourcing and cutting plywood, the installer uses a pre-fabricated ½-inch foam board substrate sized to fit the underside of a 120” x 16” overhang. The shims, also made from foam board and available in standardized thicknesses such as ¼”, ½”, ¾”, and 1”, are pre-cut to length and dimensionally matched to the substrate. They can be quickly selected based on a simple look-up table included in the kit, or via a digital or printed version of the dimensioning guide.

Using the dimensioning guide, the installer inputs the countertop thickness and the miter height, then selects the recommended combination of shims. These shims are positioned directly on the mounting surface and aligns the foam substrate board to be flush with the underside of the countertop. No diamond blade or heavy cutting equipment is required, and minimal adhesives or caulks are needed due to the clean, matched fit between all components. The lightweight and water-resistant properties of the foam board material also eliminate the need for sealing or painting.

This improvement drastically reduces on-site complexity, speeds up the installation process, lowers material costs, and minimizes the need for skilled labor or specialized tools. The resulting system not only ensures consistent and flush alignment with the mitered edge but also expands the capability of less experienced fabricators or installers to complete high-quality builds. Accordingly, the disclosed kit offers a highly efficient, scalable, and professional-grade solution that directly addresses the time, cost, and inconsistency issues inherent in conventional substrate fabrication methods.

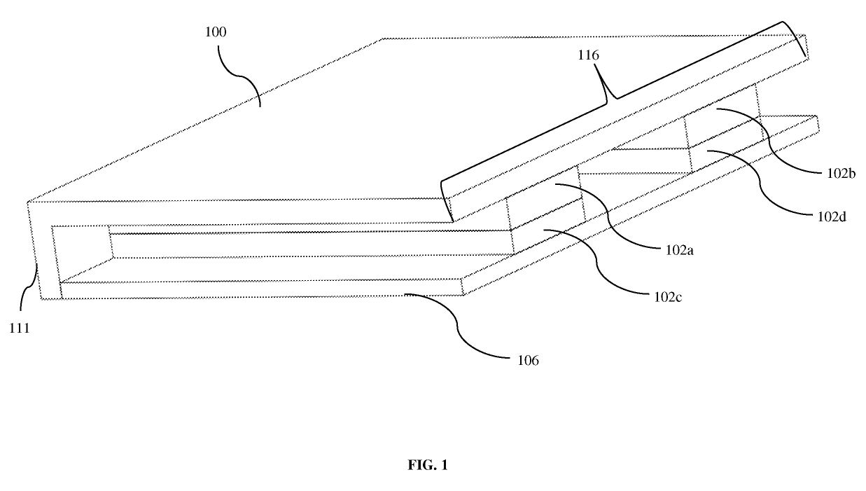

Referring now to the Figures, the disclosed embodiments relate to a kit and method for forming a substrate beneath the overhang region of a mitered-edge countertop. Referring now to FIGS. 1-4, the system or kit as installed on a mitered edge countertop is shown. The countertop 100 may be used in a variety of architectural applications, including kitchen islands, bar tops, and workstations, where a portion of the countertop projects outward beyond the underlying cabinetry or supporting structure. This overhanging section, or overhang region, is commonly used to accommodate leg space and seating, such as stools, and is structurally cantilevered from the base cabinetry or framing. Not all countertops include such overhangs. In traditional configurations, countertops are fully supported along their entire underside by base cabinets or frame structures. However, in modern kitchen and commercial design, countertop overhangs are frequently employed to increase usable space and enable seating areas. In these cases, the underside of the overhang is exposed, making its visual finish particularly important.

To enhance the visual appearance of the countertop edge, a mitered edge 111 is commonly employed. The mitered edge is formed by bonding a vertically oriented face piece to the horizontal top slab of the countertop at a miter joint, typically at a 45-degree angle. This construction creates the appearance of a much thicker slab without requiring additional solid material, resulting in a seamless, monolithic aesthetic. When used on an overhanging section of the countertop, the mitered edge 111 wraps the front and sometimes side edges of the overhang. Importantly, this creates a vertical front face whose bottom edge must align with the lower surface of the overhanging portion to avoid an exposed step or lip.

The use of a mitered edge on an overhang introduces aesthetic considerations. Aesthetically, it is desirable for the bottom of the overhanging portion to align flush with the bottom edge of the mitered face, providing a smooth and continuous plane across the underside of the countertop. This alignment ensures a professional and cohesive appearance, particularly when viewed from a seated position beneath a bar top or island. To address this, a substrate board 106 is positioned beneath the overhang and spans a substantial portion of its underside. The substrate board 106 serves as a visual alignment surface. In the illustrated embodiment, the substrate board is fabricated from a rigid foam board material and has a defined thickness 108 of approximately 1/2 inch. In one embodiment, the substrate board is fabricated from a rigid foam board material, selected for its combination of light weight, dimensional stability, and ease of handling. The board is provided in a nominal thickness 108 of approximately 1/2 inch and is dimensioned to cover a substantial portion of the underside of the overhang. In practice, the installer may need to size or trim the board to fit the precise length and depth of the overhanging section, which can vary between installations. Unlike conventional plywood, which often requires power tools or saws equipped with fine-toothed or diamond blades, the foam board substrate can be readily cut on-site using common hand tools, such as a utility knife, straightedge, or scoring blade. This allows for accurate customization and rapid installation without introducing dust, noise, or the risk of damaging surrounding surfaces. The foam board material may be selected from closed-cell extruded polystyrene (XPS), high-density polyurethane, or similar composite materials that offer both moisture resistance and a smooth, paintable or bondable surface.

Because the substrate board 106 is installed along the underside of the countertop overhang and may remain partially or fully exposed in the finished installation, particularly when viewed from a seated position at a kitchen island or bar, the surface finish of the foam board is an important consideration. In one embodiment, the foam board used for the substrate has a smooth, closed-cell outer surface that presents a clean, uniform appearance without requiring sanding or surface treatment. The finish is sufficiently smooth to be left as-is in most installations, but also readily accepts optional finishing layers such as paint, adhesive veneers, or edge banding, if a custom aesthetic is desired. Unlike plywood or raw construction board, which may require multiple steps of sanding, priming, sealing, and painting to achieve an acceptable exposed finish, the foam board used in the disclosed system requires little or no post-processing, thereby reducing labor and material costs. The board’s surface resists water, discoloration, and warping, ensuring long-term durability and a consistent appearance. Additionally, because the foam board can be trimmed with clean edges using hand tools, installers can produce a sharp, square cut line even in the field, further enhancing the visual quality of the exposed underside without requiring factory machining or specialty equipment. This ease of modification, coupled with its compatibility with the standardized shim system, provides a significant improvement over the prior art, which often relied on heavier, less adaptable plywood components requiring multiple steps of sanding, sealing, and finish work.

The disclosed system is particularly well-suited for use with a variety of countertop materials commonly employed in residential and commercial applications. These include natural stone countertops such as granite and marble; engineered stone countertops, such as quartz surfaces, which are fabricated from stone-resin composites and are frequently installed with mitered edges for a modern, thickened appearance; and porcelain countertops, which are typically thinner but harder and more brittle, often used in high-end kitchens and outdoor installations. Each of these materials presents unique installation challenges, ranging from weight distribution to precise alignment of mitered edges, and the disclosed kit offers a standardized, lightweight, and easily configurable substrate system that adapts to their differing dimensions. By eliminating the need for material-specific substrates like plywood or stone blocks, and enabling precision alignment beneath the overhang regardless of surface type, the system delivers broad compatibility with leading countertop materials in the market.

As shown in FIGS. 1-4, the board extends across the underside of the countertop overhang and is dimensioned to reach from front to back of the overhanging portion. The use of foam board allows for easy on-site cutting using hand tools such as utility knives or straightedges, eliminating the need for power saws or diamond blades. Suitable foam board materials may include extruded polystyrene (XPS), high-density polyurethane, or other closed-cell rigid foams that are lightweight, typically less than one pound per square foot, and resistant to moisture. These properties eliminate the need for additional caulking, sealing, or painting, offering advantages over traditional plywood substrates in terms of speed, weight, and finish.

The substrate board includes a polymer foam board having a density less than about one pound per square foot. The substrate board is formed from a polymer foam material characterized by a low mass per unit area, thereby reducing overall weight. The specified density provides a balance between lightweight handling. The polymer foam board may include closed-cell or open-cell polymeric materials such as expanded polystyrene, extruded polystyrene, polyurethane, polyisocyanurate, or polyethylene foams. In some embodiments, the polymer foam may further include fillers, reinforcing fibers, or surface facings to enhance moisture resistance.

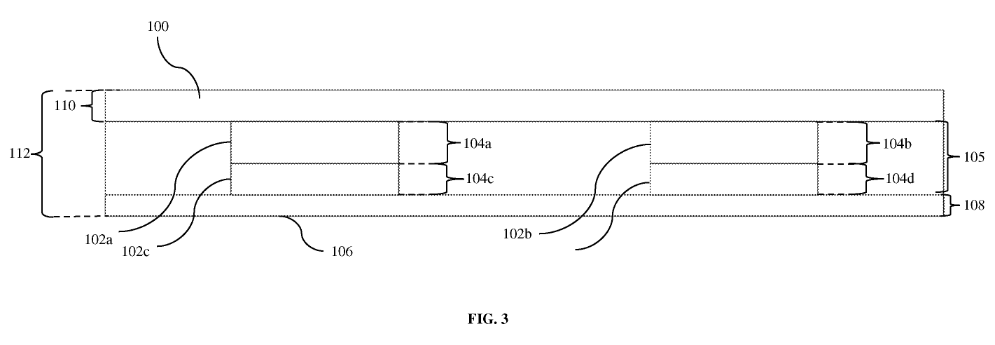

To achieve the necessary vertical alignment between the substrate board and the mitered edge, a plurality of shims 102a, 102b, 102c, 102d is provided as part of the kit. Each shim is fabricated from foam board material and has a defined thickness. The discrete shim thicknesses are selected from a predetermined set, including approximately 1/4 inch, 1/2 inch, 3/4 inch, and 1 inch, to allow installers to combine shims as needed to fill the vertical space between the substrate board and the underlying structure. As illustrated in FIGS. 1-3, multiple shims may be stacked together in layers to reach the required height. For example, in FIG. 3, shims 102a and 102c are stacked to elevate one section of the substrate board, while shims 102b and 102d elevate another section. Each individual shim has a specific shim thickness 104a, 104b, 104c, 104d, and together the shim stack and 1/2-inch substrate board match the vertical gap defined by the countertop thickness 110 and the mitered edge height 112.

Each stacked group defines a spacer height 105, and the upper surfaces of the stacked groups collectively define a spacer plane 107 providing an artificial thickness such that an upper surface 118 of the substrate board is substantially aligned with a lower edge 120 of the mitered countertop. Each stacked group includes one or more discrete shims arranged to collectively establish a predetermined vertical dimension that positions the substrate board at a desired elevation relative to the mitered countertop. The spacer heights of the individual stacked groups may be substantially identical such that the upper surfaces collectively define the spacer plane extending beneath the overhang region. In some embodiments, minor variations between individual stacked groups may be accommodated to account for installation tolerances or irregular mounting surfaces while maintaining the overall spacer plane. The spacer plane elevates the substrate board such that the upper surface of the substrate board is positioned adjacent to or substantially aligned with the lower edge of the mitered countertop. This arrangement creates an artificial thickness by visually extending the lower profile of the countertop beyond an actual thickness of the stone material. As a result, the installed assembly presents a thicker, seamless countertop appearance while reducing material costs, fabrication complexity, and overall weight that would otherwise be associated with manufacturing the countertop entirely from thicker stone material.

In some embodiments, each shim is pre-cut to a standardized planform dimension corresponding to a peripheral dimension of the substrate board. The standardized planform dimension includes a predefined and uniform length and width of each shim measured within a plane parallel to an upper surface of the substrate board, such that each shim is manufactured with consistent lateral dimensions across the plurality of shims. The peripheral dimension of the substrate board includes an outer boundary defined by edges of the substrate board that collectively establish a footprint of the substrate board in plan view. The standardized planform dimension corresponds to the peripheral dimension such that each shim is sized to substantially match, align with, or be coextensive with the footprint of the substrate board when positioned beneath the substrate board. In some embodiments, the standardized planform dimension may be equal to the peripheral dimension, while in other embodiments the standardized planform dimension may be slightly smaller to facilitate placement while maintaining substantial alignment with the footprint of the substrate board.

In some embodiments, at least one shim includes a surface feature configured to resist lateral displacement relative to an adjacent shim or the substrate board. The surface feature is formed on one or more contact surfaces of the shim and is configured to increase frictional resistance and/or provide a degree of mechanical interlocking between adjacent components. The surface feature may include textured regions, ridges, grooves, knurling, protrusions, recesses, or a high-friction coating applied to the shim surface. In some configurations, the surface feature may be integrally formed during molding or machining of the shim, while in other configurations the surface feature may be applied as a secondary treatment such as a coating or adhered layer. The surface feature engages with a corresponding surface of an adjacent shim or the substrate board to limit relative sliding movement during installation and under load conditions, including shear forces introduced by the weight of the countertop or incidental lateral forces during placement. The increased resistance to lateral displacement assists in maintaining alignment of individual shims within a stacked group and between multiple stacked groups, thereby preserving the defined spacer height and spacer plane. This contributes to stability of the substrate board and reduces the likelihood of shifting that could otherwise lead to misalignment or uneven load distribution.

In some embodiments, the plurality of stacked groups are spaced apart along a length 116 of the overhang region 100. Each stacked group is positioned at a discrete location along the length 116 such that the stacked groups are distributed between opposing ends of the overhang region 100 rather than continuously extending across an entirety of the overhang region 100. The spacing between adjacent stacked groups may vary based on the dimensions of the overhang region 100, installation preferences, and positioning requirements. In some embodiments, the stacked groups may be arranged at substantially uniform intervals, while in other embodiments the spacing may be adjusted to accommodate corners, cutouts, obstructions, or irregular countertop geometries. The spaced arrangement enables the plurality of stacked groups to collectively establish multiple elevated positioning locations for the substrate board while reducing material usage relative to a continuous underlying structure. The discrete configuration also improves installation flexibility by allowing an installer to selectively position individual stacked groups at desired locations without requiring continuous cutting or modification of materials. When the substrate board extends across the spaced stacked groups, the arrangement facilitates formation of a continuous lower profile that aligns with the mitered countertop and creates a flush visual appearance along the overhang region 100.

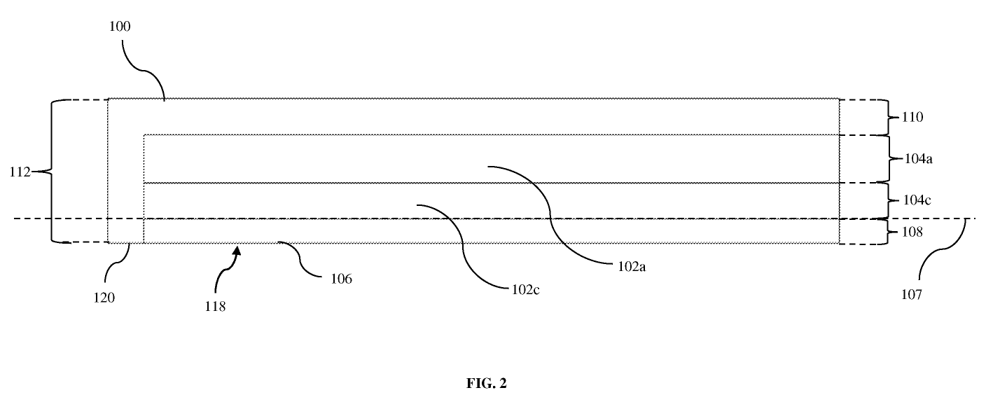

The countertop thickness 110, shown in FIGS. 2 and 3, is the vertical thickness of the horizontal slab portion of the countertop. The mitered edge height 112, by contrast, is the total height of the mitered face bonded to the edge of the countertop. In mitered constructions, the edge height typically exceeds the countertop thickness, creating a gap beneath the countertop surface that must be filled flush. This relationship, between the mitered edge height 112 and the countertop thickness 110, defines the necessary combined height of the shim stack and the substrate board. For example, if the mitered edge height is 2 inches and the countertop thickness is 1-1/2 inches, the combined shim height must be 1/2 inch to ensure that the 1/2-inch substrate board finishes flush with the bottom of the mitered edge.

The plurality of shims are arrangeable to collectively define the spacer height 105 corresponding to the selected combination of shim thicknesses. The plurality of shims are configured to be selectively stacked or combined in varying quantities such that the individual shim thicknesses cumulatively establish a total vertical dimension. The total vertical dimension corresponds to a predetermined combination of shim thicknesses identified for a given installation condition, thereby enabling formation of a spacer height that aligns with the required positional relationship of the mitered countertop.

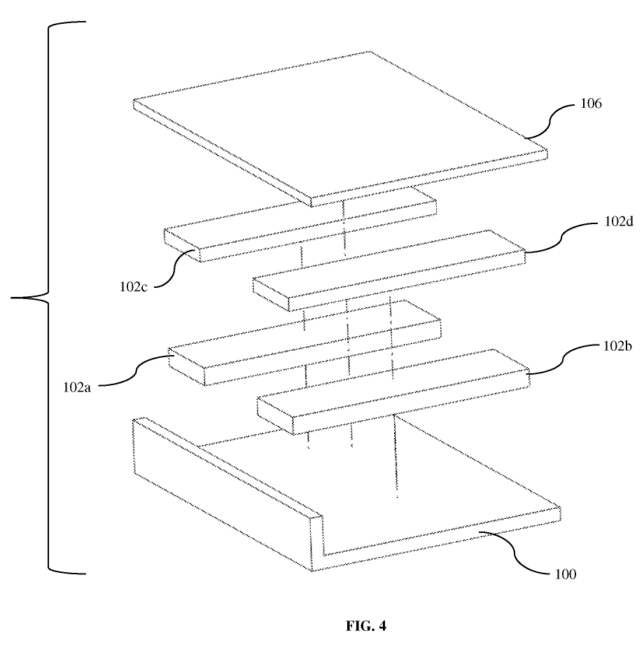

Referring now to FIG. 4, an exploded underside perspective view of the system is shown, illustrating the relationship between the primary components included in the kit. In this view, the substrate board 106 is shown spaced above the plurality of shims 102a, 102b, 102c, 102d, each having a defined thickness 104a, 104b, 104c, 104d, and arranged on the underside of the overhanging portion of the countertop 100. This orientation highlights how the individual components of the system are layered during installation: the shims are first affixed to the mounting surface, and the substrate board is then bonded to the top of the shim stack. The exploded view clarifies how the modularity of the shims allows the system to adapt to a variety of countertop-miter combinations, while maintaining dimensional stability and ease of installation.

In the example embodiments depicted in FIGS. 1-4, the countertop thickness 110 is approximately 0.75 inches, and the mitered edge height 112 is approximately 3 inches. This creates a vertical offset of 2.25 inches between the bottom of the overhanging portion of the countertop and the bottom of the mitered face. To span this offset, the system uses a 0.5-inch-thick substrate board 106, combined with shims totaling 1.75 inches in vertical height. As illustrated in FIG. 4 and previously in FIG. 3, this height can be achieved, for example, by stacking a 1-inch shim and a 3/4-inch shim, such as shims 102a and 102c, beneath the substrate board. This specific combination provides a flush and stable structure that brings the bottom surface of the substrate board into planar alignment with the lower edge of the mitered face, ensuring a clean and professional finish across the visible underside of the countertop overhang.

The system further includes an artificial countertop thickness defined by a collective thickness of the substrate board, the plurality of discrete shims, and the mitered countertop. The artificial thickness may corresponded with the mitered edge height 112. The mitered countertop includes an actual thickness 110 that is less than an apparent overall thickness, that is the artificial thickness, presented after installation. The plurality of discrete shims are positioned beneath the substrate board to elevate the substrate board relative to an underlying spacer surface, and the substrate board is positioned beneath the mitered countertop such that the combined vertical dimensions of the shims, the substrate board, and the mitered edge collectively define an enlarged visible profile. This combined thickness creates the appearance of a substantially thicker countertop structure than the actual thickness of the stone slab alone. The arrangement enables installers to achieve a seamless and flush aesthetic associated with thicker stone installations while reducing material costs, overall weight, and fabrication complexity that would otherwise be required to produce the same visual effect using solid stone material alone.

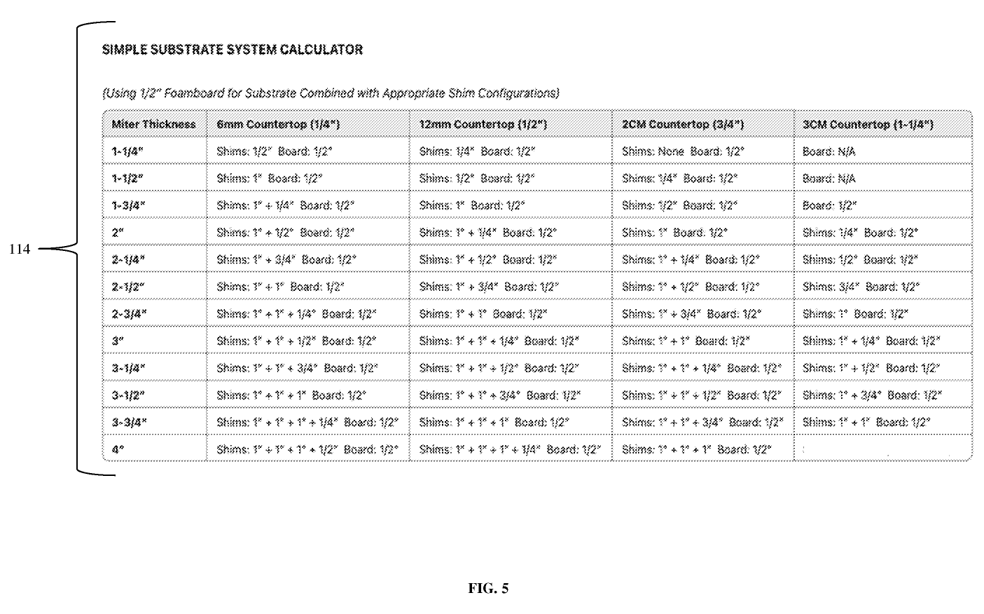

Referring now to FIG. 5, a dimensioning guide 114 is shown. This component is a central element of the disclosed kit, enabling the installer to quickly and accurately determine which shim combination is required for a given countertop installation. The kit, as a whole, includes three primary components. Specifically, the kit includes a plurality of shims formed from foam board, each having a standardized thickness, e.g., 1/4 inch, 1/2 inch, 3/4 inch, and 1 inch. The kit further includes a substrate board 106, also formed from foam board material and having a fixed thickness 108, which in certain embodiments is approximately 0.5 inch. The kit further includes a dimensioning guide 114, which may be provided as a printed chart, a digital reference, or a software tool. The shims and substrate board are pre-cut and packaged in standard sizes to enable modular selection and assembly without trimming or modification in the field.

The dimensioning guide 114, as shown in FIG. 5, cross-references common countertop thicknesses and mitered edge heights to identify the optimal combination of shim thicknesses required to fill the vertical offset beneath the overhang. In the present example, where the countertop is 0.75 inches thick and the mitered edge is 3 inches tall, the installer would locate these two values on the dimensioning chart. The guide would then indicate that the necessary shim stack height is 1.75 inches, and further recommend a suitable shim combination such as a 1-inch shim and a 3/4-inch shim. This eliminates the need for on-site calculation or measurement, allowing even novice installers to complete the configuration with precision and confidence. By systematizing what was once a trial-and-error process or labor intensive process, the guide significantly reduces installation time, material waste, and the likelihood of error, while enhancing consistency across multiple job sites.

The dimensioning guide may include indicia that correlate the countertop thickness, the mitered edge height, and the selected combination of the predetermined shim thickness. In one example embodiment, the indicia refers to perceptible markings, symbols, or information-bearing features that convey data to a user. Such indicia may include visual, tactile, or machine-readable elements that communicate relationships, measurements, or instructions. In a more specific context, the indicia includes alphanumeric characters, graphical representations, color coding, or tabulated data arranged to express correlations between measurable parameters. The indicia may be presented in printed, etched, embossed, or digitally displayed form depending on the implementation of the dimensioning guide. In operation within the system, the indicia functions as an interface between user-provided inputs and the physical selection of shims. The indicia enables an installer to identify a correspondence between a countertop thickness and a mitered edge height and a resulting combination of shim thicknesses. The indicia thereby guides assembly of the plurality of shims to achieve a target spacer height that aligns the substrate board with a lower edge of the mitered countertop. In another example embodiment, the indicia may be arranged in a matrix or lookup format that simplifies field use and reduces estimation or calculation by the installer. The indicia as described provides a structured and repeatable mechanism for translating dimensional inputs into a defined shim configuration, thereby reducing variability associated with manual measurement and estimation techniques. The indicia supports more consistent alignment of the substrate board relative to the mitered countertop edge and facilitates efficient installation by providing readily interpretable guidance without requiring specialized calculation or iterative adjustment.

In one embodiment, the dimensioning guide includes a printed chart including a lookup table relating the countertop thickness and the mitered edge height to the selected combination of shim thicknesses. The printed chart is arranged to present the countertop thickness and the mitered edge height as input variables aligned along corresponding axes or fields, with intersecting entries identifying the associated combination of shim thicknesses. The lookup table provides a predetermined mapping that enables rapid identification of the selected combination without calculation, thereby facilitating consistent and repeatable selection of shims during installation. The lookup table includes a matrix of rows and columns in which one of the countertop thickness or the mitered edge height is listed along a first axis and the other is listed along a second axis, and each intersection defines a prescribed combination of shim thicknesses. The lookup table may further include labels, headings, or color-coded regions to distinguish ranges of values and to facilitate rapid identification of the appropriate shim combination during installation.

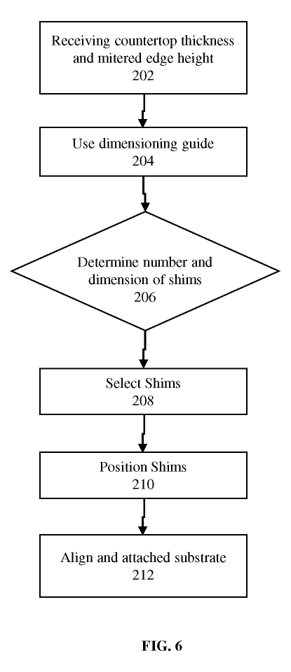

The method of use, further illustrated in FIG. 6, aligns with the components and functionality of the kit described above. At step 202, the installer receives or measures the countertop thickness and mitered edge height, which are 0.75 inches and 3 inches, respectively, in this example. At step 204, the installer consults the dimensioning guide 114 to determine that a total shim height of 1.75 inches is needed. At step 206, the number and thicknesses of shims are determined, such as one 1-inch and one 3/4-inch shim. At step 208, the appropriate shims are selected from the pre-supplied plurality of foam board shims in the kit.

At step 210, the shims are positioned on the mounting surface beneath the countertop overhang, and at step 212, the substrate board 106 is aligned and affixed on top of the shim stack such that its lower surface aligns flush with the bottom of the mitered edge. Once the appropriate shim configuration has been determined using the dimensioning guide, the selected shims are positioned and affixed to the mounting surface, which is typically the underside of the countertop overhang or any adjoining framing or support members. The shims may be adhered using a construction-grade adhesive, foam-safe glue, or a pressure-sensitive bonding agent suitable for use with foam board materials. After the shims are secured in place, the substrate board 106 is aligned above the shim stack and attached using a similar bonding method. In some embodiments, additional mechanical fasteners such as finish nails or screws may be used in combination with adhesive to ensure long-term hold, particularly when the mounting surface is wood or framing lumber. The foam board’s smooth, closed-cell surface readily accepts adhesives, allowing for clean and durable bonding without requiring surface treatment or primer. Importantly, the use of lightweight foam components reduces the overall load on the adhesive bond, eliminating the need for clamps or bracing during curing. Once attached, the bottom surface of the substrate board aligns flush with the bottom of the mitered edge, providing a visually seamless finish. This results in a visually seamless or flush underside of the countertop, suitable for high-end finishes and visible overhang applications such as kitchen islands and bar tops.

The kit and accompanying method provide a comprehensive and modular solution for forming a flush substrate surface beneath mitered countertop overhangs, eliminating the material inefficiencies, dimensional inconsistencies, and labor-intensive processes associated with prior art systems. The coordinated use of standardized foam components, pre-calculated dimensioning, and intuitive assembly reduces on-site complexity and ensures repeatable, professional-grade results.

Commercially offering the disclosed system as a pre-configured kit provides substantial advantages over conventional approaches, which typically require installers to independently source, cut, and assemble various materials such as plywood panels, stone or wood shims, adhesives, and sealing components. By bundling the key components, namely, a set of standardized foam board shims, a substrate board, and a dimensioning guide, into a single packaged offering, the kit streamlines the procurement process, eliminates material compatibility concerns, and reduces preparation time. This enables distributors, fabricators, and installers to quickly obtain all required components in one purchase, reducing logistical complexity and ensuring that each part is specifically designed to integrate with the others. Moreover, the inclusion of the dimensioning guide in the kit allows for consistent and accurate configuration without reliance on field calculations or specialized knowledge, which significantly reduces installation error and rework. In contrast to prior art methods where materials must be manually measured, cut, or adapted on-site, often using heavy tools and variable-quality materials, the commercial kit provides a ready-to-use, modular, and field-adaptable system that ensures professional results with minimal training. The standardization of the kit components not only improves the efficiency and repeatability of installations but also enables scalable production, predictable material costs, and compatibility with a wide range of countertop styles and dimensions, thus offering a significant improvement over fragmented and improvised substrate practices in the field.

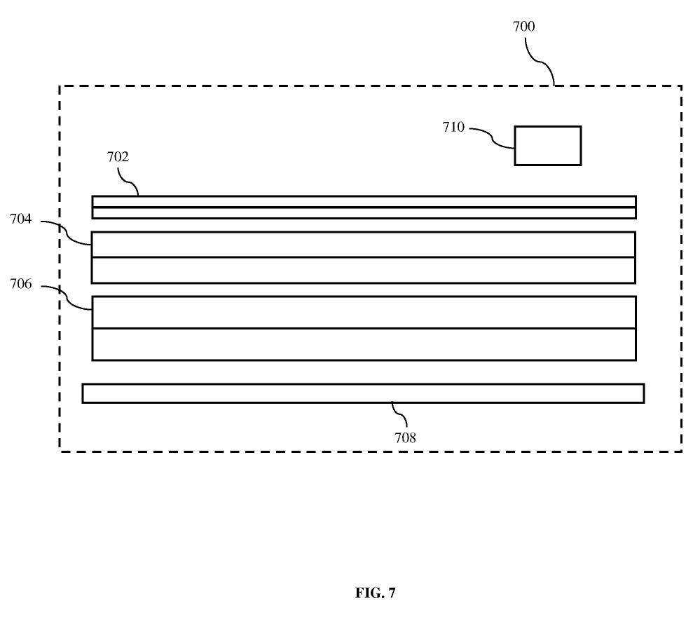

Referring now to FIG. 7, a kit 700 for providing a substrate beneath an overhang region of a mitered countertop is shown, according to an example embodiment. The kit provides a preconfigured set of components that collectively streamline installation of a substrate beneath a mitered countertop overhang by reducing the need for custom fabrication, measurement iteration, and material selection at the jobsite. The shims 702, 704, and 706 having predetermined discrete thicknesses enables an installer to achieve a wide range of spacer heights using a limited number of standardized components, thereby reducing material waste and eliminating the need to cut or modify shims during installation. The substrate board 708 provided at a defined thickness further reduces variability by supplying a consistent layer that is compatible with the shim system. The dimensioning guide 710 enhances convenience by providing a direct correlation between installation parameters and shim selection, which minimizes estimation and reduces installation time. The ability to quickly determine a proper shim combination improves repeatability across different installations and reduces the likelihood of misalignment or rework. In embodiments including a digital interface, the guide further simplifies the process by automating selection and reducing user error. The use of lightweight polymer foam materials contributes to ease of handling and transport. This reduces installer fatigue and facilitates faster placement. Standardized planform dimensions of the shims and substrate board promote consistent alignment and load distribution. Surface features that resist lateral displacement further enhance stability during and after installation. Collectively, the kit improves cost efficiency by lowering labor time, reducing material waste, and minimizing the need for specialized tools or custom components, while also improving installation consistency and reliability.

The kit is configured to create an artificial thickness beneath a countertop overhang for aesthetic purposes by visually extending the apparent thickness of the countertop beyond the actual thickness of the stone material. In many mitered countertop installations, the visible edge is constructed to appear substantially thicker than the underlying stone slab. The kit facilitates continuation of that visual effect beneath the overhang region by positioning the substrate board at a height that aligns with the lower edge of the mitered countertop, thereby creating a flush and seamless appearance. As a result, the installed assembly presents the appearance of a thicker solid stone structure while avoiding the cost, weight, and material requirements associated with using a full-thickness stone slab throughout the overhang region. The plurality of shims enables precise vertical adjustment to accommodate varying countertop thicknesses and mitered edge heights, while the substrate board provides a continuous underlying surface that visually completes the lower profile of the overhang. The dimensioning guide further simplifies installation by allowing an installer to quickly determine an appropriate shim configuration based on measured dimensions, thereby reducing trial-and-error adjustments. The kit provides a convenient and cost-effective solution for achieving a high-end seamless aesthetic without requiring custom fabrication, excessive stone material, or complex field modifications. By utilizing standardized components that can be rapidly selected and assembled, the kit reduces labor time, minimizes material waste, and allows installers to consistently replicate the appearance of a thicker countertop construction in a more efficient manner.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A kit for providing a substrate beneath an overhang region of a mitered countertop, the kit comprising:
a plurality of shims, each shim having a predetermined thickness selected from the group consisting of about 1/4 inch, 1/2 inch, 3/4 inch, and 1 inch;
a substrate board having a thickness of about 1/2 inch; and
a dimensioning guide including indicia that correlate (i) a countertop thickness and (ii) a mitered edge height with (iii) a selected combination of the predetermined shim thicknesses,
wherein the plurality of shims are arrangeable to collectively define a spacer height corresponding to the selected combination of shim thicknesses.

2. The kit of claim 1, wherein the substrate board comprises a polymer foam board having a density less than about one pound per square foot.

3. The kit of claim 1, wherein the dimensioning guide comprises a printed chart including a lookup table relating the countertop thickness and the mitered edge height to the selected combination of shim thicknesses.

4. The kit of claim 1, wherein the dimensioning guide comprises a digital interface configured to output the selected combination of shim thicknesses in response to inputs of the countertop thickness and the mitered edge height.

5. The kit of claim 1, wherein each shim is pre-cut to a standardized planform dimension corresponding to a peripheral dimension of the substrate board.

6. The kit of claim 1, wherein the substrate board comprises a water-resistant material.

7. An installation kit for a countertop, the installation kit consisting of:
a plurality of shims, each shim having a thickness selected from the group consisting of about 1/4 inch, 1/2 inch, 3/4 inch, and 1 inch;
a substrate board having a thickness of about 1/2 inch; and
a dimensioning guide including indicia correlating a countertop thickness and a mitered edge height to a combination of the shim thicknesses.

8. The installation kit of claim 7 wherein at least one shim includes a surface feature configured to resist lateral displacement relative to an adjacent shim or the substrate board.

9. An installation system for providing a substrate beneath an overhang region of a mitered countertop, comprising:
a substrate board; and
a plurality of discrete shims arranged beneath the substrate board in a plurality of stacked groups, each shim having a predetermined thickness selected from a set of discrete thicknesses,
wherein each stacked group defines a spacer height, and upper surfaces of the stacked groups collectively define a spacer plane providing an artificial thickness such that an upper surface of the substrate board is substantially aligned with a lower edge of the mitered countertop.

10. The installation system of claim 9 wherein at least one shim of the plurality of discrete shims includes a surface feature configured to resist lateral displacement relative to an adjacent shim or the substrate board.

11. The installation system of claim 10, wherein the set of discrete thicknesses comprises 1/4 inch, 1/2 inch, 3/4 inch, and 1 inch.

12. The installation system of claim 11, wherein each stacked group comprises at least two of the shims.

13. The installation system of claim 12, wherein the plurality of stacked groups are spaced apart along a length of the overhang region.

14. The installation system of claim 13, wherein the substrate board spans across at least two of the stacked groups.

15. The installation system of claim 14, further comprising an artificial countertop thickness defined by a collective thickness of the substrate board, the plurality of discrete shims, and the mitered countertop.

16. The installation system of claim 15, wherein each shim has a planform dimension substantially matching a footprint of the substrate board.

17. The installation system of claim 16, wherein the substrate board comprises a polymer foam material.

18. The installation system of claim 17, wherein the polymer foam material has a density less than about one pound per square foot.

19. The installation system of claim 18, wherein the substrate board has a thickness of about 1/2 inch.

20. The installation system of claim 19, wherein the substrate board comprises a water-resistant material.
